(19) United States
(12) Patent Application Publication
(10) Pub. No.: US 2007/0256942 A1
(43) Pub. Date: Nov. 8, 2007

(54) Measurement Of Corrosivity

(75) Inventor: Eric Atherton, Witney, Oxfordshire (GB)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Capcis Limited, Long Hanborough, Oxfordshire (GB)

(21) Appl. No.: 11/792,169

(22) PCT Filed: Dec. 2, 2005
(86) PCT No.: PCT/GB05/04642

§ 371 Date: Jun. 1, 2007

(30) Foreign Application Priority Data
Dec. 3, 2004 (GB) 0426551.8

(51) Int. Cl. G01N 17/04

(52) U.S. Cl. 205/775.5

(57) ABSTRACT

A downhole corrosion monitor comprises a sensor head suspended on a cable, the cable being extensible so as to raise and/or lower the sensor head downhole and having a signal conductor to return data from the sensor head to the surface, the sensor head comprising a plurality of mutually insulated electrical sensors and means for detecting the voltages and/or currents existing therebetween. The electrical sensors can detect corrosion rate by one or both of linear polarisation rate and electrochemical noise and thus there will usually be at least three. The sensor head can further comprise sensors for at least one of temperature, pressure, vibrations, acceleration, flow sand rate and water cut. A corresponding method of obtaining data is also disclosed, together with a method of designing an item of downhole equipment and the item of downhole equipment thus designed.

### FIELD OF THE INVENTION

The invention relates to a downhole corrosion monitoring tool. Preferred embodiments are suitable for deployment into a wellbore by wireline, for the purpose of acquiring corrosion data. The invention also relates to a means of acquiring real time data via wireline.

### BACKGROUND ART

The potential severity of the downhole environments and its detrimental effects, both upon operating and maintenance expenditure, is well documented. Therefore, techniques which prevent or inhibit the degree of corrosion downhole have long been employed. These techniques have included the replacement of carbon steel drill pipe or production tubing with corrosion resistant alloys (CRAS) and the implementation of chemical inhibitor management programs. However, as explained in U.S. Pat. No. 5,627,749, the downhole corrosion rate may not be consistent throughout the depth of the wellbore as the environmental conditions such as pressure, temperature, fluid density or velocity, are subject to change. Therefore, the effectiveness of an inhibitor may not be ideal throughout the entire well profile and the optimization of an inhibitor system cannot be achieved without knowing the corrosion rate relative to the well bore depth.

Earlier apparatus designed to measure the corrosion rate included the weight loss coupon. The coupon, of known weight and similar material to the production tubing (etc.) provide a cumulative corrosion rate by measuring the weight lost by the coupon over a known period. This metal loss technique was later developed further, and U.S. Pat. No. 5,627,749 discloses an electrical resistance corrosion sensor for downhole deployment with memory to facilitate data storage. This tool records electrical resistance data which is downloaded post retrieval and on surface, providing metal loss data over the deployed period.

While this tool is suitable for acquiring corrosion data at a single or a plurality of depths against time, it is not able to provide continuous corrosion data against variable depth. As a result, it is unable to assist in the identification of depths at which the production tubing etc. is particularly vulnerable to corrosion.

As an alternative to monitoring corrosion in a downhole environment, flow simulation software models have been designed to predict corrosion downhole against depth. Although these models set out to solve the problems outlined, they have not been fully validated due to the absence of a monitoring device. Such models cannot be relied on until they can be validated in this way.

### SUMMARY OF THE INVENTION

The present invention therefore provides a downhole corrosion monitor, comprising a sensor head suspended on a cable, the cable being extensible so as to raise and/or lower the sensor head downhole and having a signal conductor to return data from the sensor head to the surface, the sensor head comprising a plurality of mutually insulated electrical sensors and means for detecting the voltages and/or currents existing therebetween.

To extend the cable, it is convenient to provide it in wound form on a winch.

It is preferred that the electrical sensors detect corrosion rate by one or both of linear polarisation rate and electrochemical noise. To this end, there can be at least three such electrical sensors. The sensor head can further comprise sensors for at least one of temperature, pressure, vibration, acceleration, flow, sand rate and water cut.

The present invention also relates to a method of monitoring downhole corrosion, comprising the steps of providing a sensor head suspended on a cable, extending the cable so as to lower the sensor head downhole, obtaining corrosion rate data from the sensor head, varying the depth of the sensor head by way of the cable, repeating these steps as required, returning data from the sensor head to the surface via a signal conductor in the cable, wherein the sensor head comprises a plurality of mutually insulated electrical sensors and means for detecting the voltages and/or currents existing therebetween.

Further, the invention provides a method of designing an item of downhole equipment, comprising the steps of obtaining data as to corrosion rates with depth as set out above, and designing the item so as to have greater corrosion protection measures at areas of higher corrosion rate as revealed by the data. The greater corrosion protection measures can include the use of corrosion resistant alloys and the provision of chemical injection mechanisms. The invention also relates to an item of downhole equipment having varied corrosion protection along its length as a result of having been designed in this manner.

### BRIEF DESCRIPTION OF THE DRAWINGS

An embodiment of the present invention will now be described by way of example, with reference to the accompanying figures in which;

FIG. 1 shows the relative response times of general corrosion monitoring techniques;

FIG. 2 shows the relative response times of localized corrosion monitoring techniques;

FIG. 3 shows a simplified schematic of a wellbore and a system for conducting EN and LPR measurements;

FIG. 4 shows the downhole corrosion monitoring tool electrode section;

FIG. 5 shows the downhole corrosion monitoring tool electronics section;

FIG. 6 illustrates the protective covering; and

FIG. 7 shows a flow chart embodying the corrosion monitoring tool of the present invention.

### DETAILED DESCRIPTION OF THE EMBODIMENTS

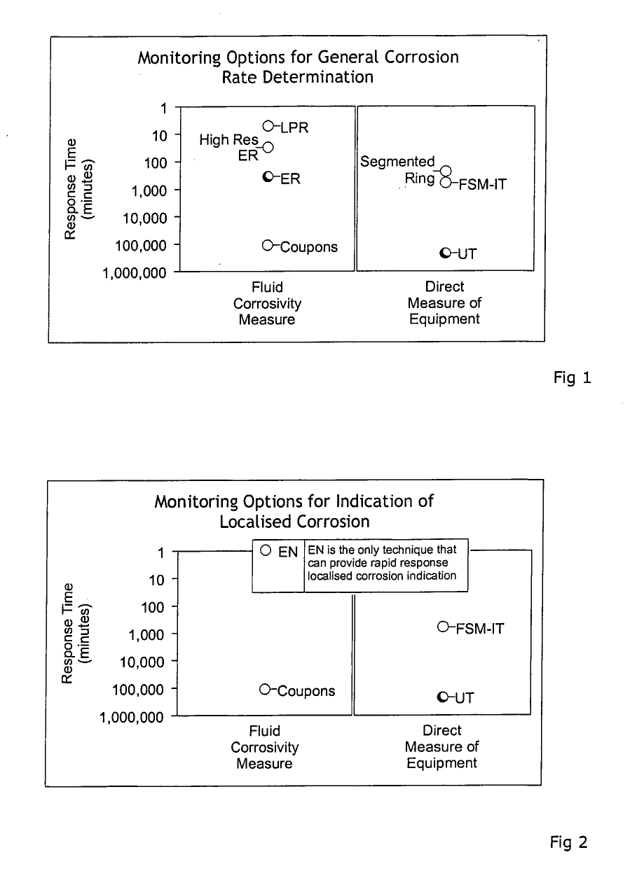

The present invention aims to overcome the disadvantages associated with current downhole corrosion monitoring techniques and to validate existing corrosion modelling software packages. This is achieved by utilizing a single downhole tool to perform linear polarization resistance (LPR) and electrochemical noise (EN) techniques. These techniques respond to the corrosivity of a fluid much more rapidly, as shown in FIGS. 1 and 2, and enable an operator to deploy the tool via wireline and to obtain real time data.

As compared to other techniques such as electrical resistance measurement (ER) and weight loss coupons, it can be seen that LPR and EN techniques offer a much shorter response time and are thus suited to development into a realtime monitor capable of reporting the corrosion rates along the length of a wellbore.

The tool, while initially moving, aims to passively monitor naturally occurring fluctuations in current and voltage so as not to affect the corrosion occurring in a downhole environment, thus determining the fluid corrosivity against depth in real time. This produces an indication of the relative localized and general corrosion in the downhole environment in the form of a well profile and, therefore, highlighting the depths particularly susceptible to corrosion. The invention can then be used for further analysis any point depth of interest, to indicate the relative localized corrosion against time and the general corrosion rate.

Therefore, the present invention must be suitable for deployment into a downhole environment by wireline so that the invention is suspended with the probe substantially perpendicular to the production tubing and in the fluid flow, exposing the electrode section to the same, or similar, conditions as the production tubing.

Depolyment

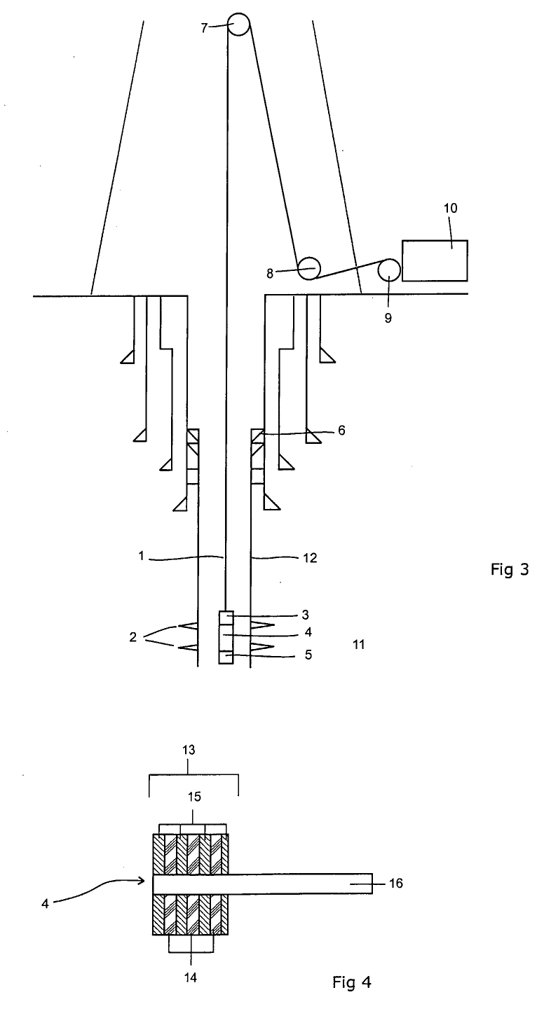

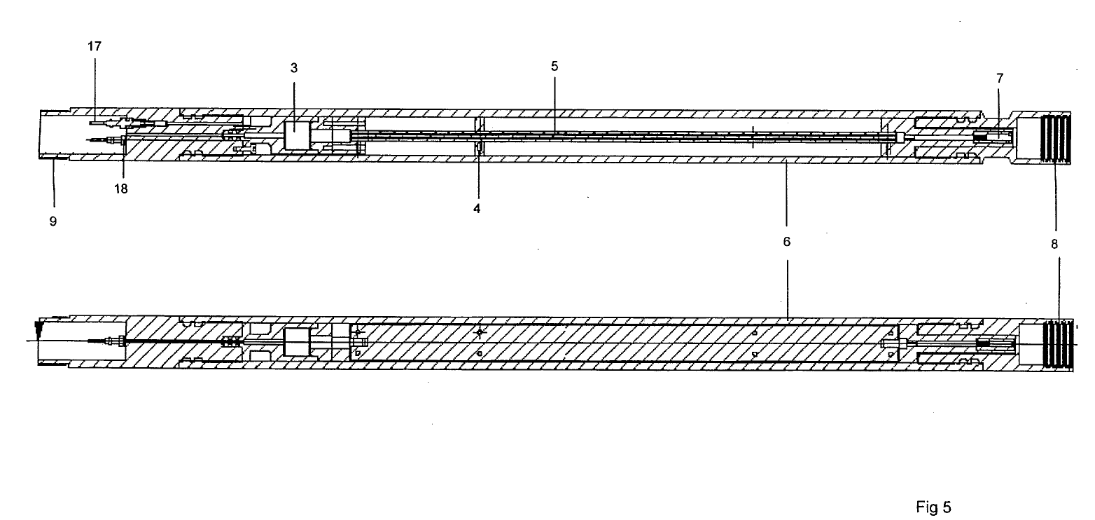

As shown in FIG. 3, the downhole corrosion monitoring tool 11 is for deployment into a wellbore by a wireline 1. The downhole corrosion monitoring tool 11 consists of an electronic section 4 (shown in FIG. 4) and a probe end 5. This is connected on surface to a 1⅜″ cable logging head 3 (FIG. 4). The wireline logging head 3 provides a means of mechanically connecting the invention to the wireline 1 and electrically connecting the tool 11 to the wireline 1 for the purposes of providing power communication.

Once connected to the wireline, 1, the tool is threaded through the upper and lower sheave wheels 7, 8 and lowered into the production tubing 12 by a winching device 9. In this way, the tool can be positioned at any depth from below the perforation zone 2 to surface and data can be acquired at a resolution dictated by the speed of winch 9.

The uphole end of the wireline is connected to a data acquisition and presentation system 10 which provides a means of viewing the data in real time and storing the raw data for post operation analysis as required.

Tool Specifications

The downhole corrosion monitoring tool predominantly consists of two sections: an electronic section and a probe section.

Electrode Section

The downhole corrosion monitoring tool utilizes electrochemical noise and linear polarization techniques to determine a corrosion rate and an indication of the relative localized corrosion and to determine corrosion rate. Both techniques are performed using the same electrode stack 13 (FIG. 4) within the probe configuration. The electrode stack 13 consists of three identical disc electrodes 14, each made of a material representative of that in the environment in which the fluid corrosivity is being measured. Each of the electrodes are separated by an insulating Polyetheretherketone (PEEK) disc 15 with one additional PEEK disc on the top and bottom of the electrode stack.

The stacked discs are mounted onto a rod 16 through which the electric wires are threaded. These wires are electrically connected to the electronics section via the connector electrode array 17 (FIG. 5) in the base of the electronics section. The mechanical connection is formed by a fine male to female thread 18.

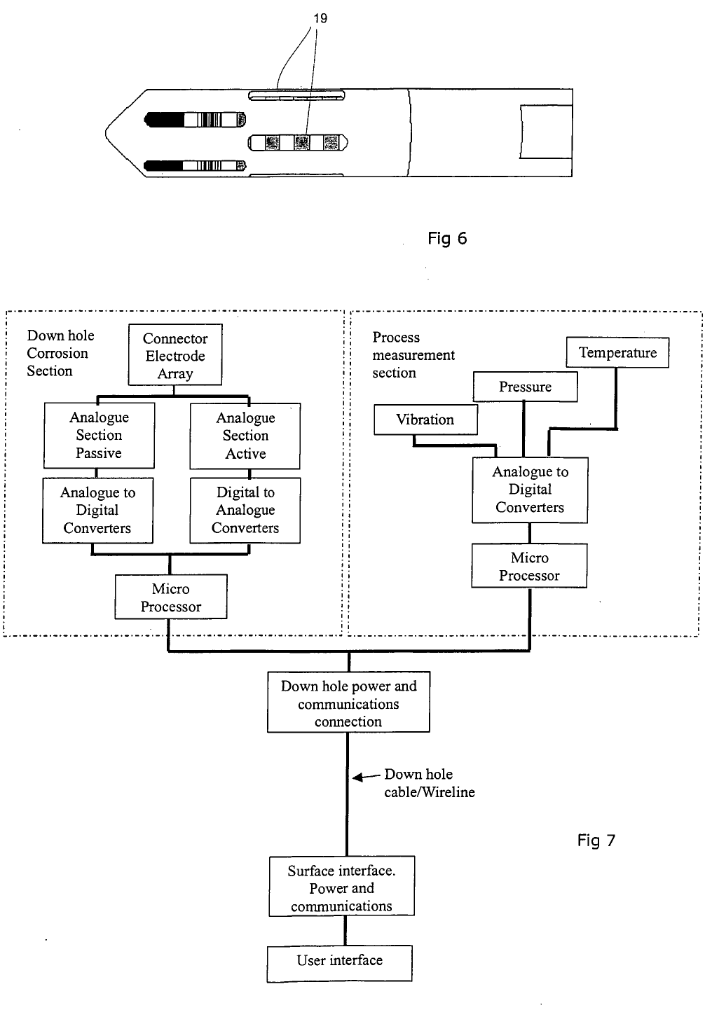

The whole probe stack is protected by a coated metallic bottom nose (FIG. 6) which allows sufficient fluid to reach the electrode via apertures 19 but which nevertheless provides mechanical protection to the probe. Additionally, the threaded end allows the bottom nose to be held in place.

Operation of the Corrosion Tool

FIG. 7 shows the operation of the corrosion monitoring tool as a flowchart. The diagram is split into two main sections the “down-hole corrosion section” and the “process measurement section”.

Down-hole Corrosion Section

The downhole corrosion section of the flowchart consists of the processing of data obtained from the electrode array.

Corrosion Measurement

The corrosion section uses analogue electronics to measure corrosion activity on the electrode array. This may be passive measurement such as ECN (Electrochemical Noise) or Active measurement such as LPR (Linear polarization resistance).

The corroding electrode array produces voltage and current values that are measured by the analogue sections and then converted into a digital value using the ADC (Analogue to digital converters).

The Corrosion tool is capable of combining 2 measurements on the same electrode array and uses a DAC (Digital to Analogue converter) to impose or disrupt voltage and currents on the electrode array.

The microprocessor controls the functionality of the corrosion measurement and communicates up-hole. The microprocessor can receive commands to tell it when and how to do measurements. From the resulting measurements it is possible to produce corrosion values that are indicative of the corrosivity of the environment in which the electrode array is placed. The measurements made include: Corrosion rate, solution resistance, Polarization resistance and Localization indicators.

Process Measurement Section

In some applications it may be necessary to combine the corrosion measurement with process data. Accurate process data enables better understanding of the corrosion mechanism.

This is achieved by combining the corrosion section with a process measurement section. The corrosion measurements and the process measurements are taken in close proximity to each other. The resulting data is an accurate reflection of the corrosion environment and the process that caused it.

Process Sensors

The examples in FIG. 7 are temperature, pressure and vibration sensors, the outputs of which are interfaced to a ADC. There is a down-hole microprocessor for data management and communications. It is also possible to incorporate other process measurements such as temperature, pressure, vibration, acceleration, flow, sand rate and water cut.

Down-hole power and communications connection

This is a single connection that supplies power and communications on one conductor. The power for the corrosion tool is supplied at the surface interface. The power and the communications are capable of running the length of the down-hole pipe and provide continual real-time data collection from the down-hole corrosion tool for corrosion and process data.

User Interface

The data can be presented real-time by interfacing to a data control system or data historian, this data can then be used by operators. This would be typical for permanent installations. The data can also collected and graphed at the surface interface. This would be more applicable for temporary installation, when running well testing.

Data Usage

The data obtainable from such a monitor is potentially very useful. Given the instantaneous corrosion rate and details of how this varies with depth, a designer of (for example) production tubing can tailor the materials and corrosion inhibition mechanisms to meet the challenges of the downhole environment. It is common for there to be specific localised areas where corrosion rates are generally higher than elsewhere, and techniques which monitor the general or averaged corrosion rate will fail to take sufficient precautions in these areas, or will over-engineer the corrosion protection in other areas.

Thus, using the information gained form this sensor, a designer can locate corrosion inhibitor systems such as chemical injection systems and/or use differing materials at different points along the item, deploying corrosion resistant alloys at strongly corrosive areas and other alloys at areas of lesser corrosivity. Those other alloys might have other properties rendering them advantageous at that location, or they may simply be less expensive.

It will of course be understood that many variations may be made to the above-described embodiment without departing from the scope of the present invention.

1. A downhole corrosion monitor, comprising a sensor head suspended on a cable, the cable being extensible so as to raise and/or lower the sensor head downhole and having one or more conductors to return data from the sensor head to the surface, the sensor head comprising a plurality of mutually insulated electrical sensors and means for detecting the voltages and/or currents existing therebetween.

2. The downhole corrosion monitor according to claim 1 in which the cable is wound on a winch.

3. The downhole corrosion monitor according to claim 1 in which the electrical sensors detect corrosion rate by one or both of linear polarisation rate and electrochemical noise.

4. The downhole corrosion monitor according to claim 1 in which there are at least three electrical sensors.

5. The downhole corrosion monitor according to claim 1 in which the sensor head further comprises sensors for at least one of temperature, pressure, vibration, acceleration, flow, sand rate and water cut.

6. A method of monitoring downhole corrosion, comprising the steps of:
i. providing a sensor head suspended on a cable
ii. extending the cable so as to lower the sensor head downhole
iii. obtaining corrosion rate data from the sensor head;
iv. varying the depth of the sensor head by way of the cable;
v. repeating steps iii. and iv. as required
vi. returning data from the sensor head to the surface via a signal conductor in the cable;

7. A method of designing an item of downhole equipment, comprising the steps of:
i. obtaining data as to corrosion rates with depth as set out in claim 6;
ii. designing the item so as to have greater corrosion protection measures at areas of higher corrosion rate as revealed by the data.

8. The method according to claim 7 in which the greater corrosion protection measures are selected from corrosion resistant alloys and chemical injection mechanisms.

9. An item of downhole equipment having varied corrosion protection along its length, the protection measures having been located according to the method of claim 7.

10. (canceled)

11. An item of downhole equipment having varied corrosion protection along its length, the protection measures having been located according to the method of claim 8.

12. The downhole corrosion monitor according to claim 2 in which the electrical sensors detect corrosion rate by one or both of linear polarisation rate and electrochemical noise.

13. The downhole corrosion monitor according to claim 2 in which there are at least three electrical sensors.

14. The downhole corrosion monitor according to claim 3 in which there are at least three electrical sensors.

15. The downhole corrosion monitor according to the method of claim 2 in which the sensor head further comprises sensors for at least one of temperature, pressure, vibration, acceleration, flow, sand rate and water cut.

16. The downhole corrosion monitor according to the method of claim 3 in which the sensor head further comprises sensors for at least one of temperature, pressure, vibration, acceleration, flow, sand rate and water cut.

17. The downhole corrosion monitor according to the method of claim 4 in which the sensor head further comprises sensors for at least one of temperature, pressure, vibration, acceleration, flow, sand rate and water cut.
